(19) United States
(12) Patent Application Publication
(10) Pub. No.: US 2004/0057475 A1
(43) Pub. Date: Mar. 25, 2004

(54) High-power pulsed laser device

(76) Inventors: Robert Frankel, Rochester, NY (US); John Hoose, Fairport, NY (US)

Correspondence Address: ROPES & GRAY LLP, ONE INTERNATIONAL PLACE, BOSTON, MA, 02110-2624, US

(21) Appl. No.: 10/254,966

(22) Filed: Sep. 24, 2002

(51) Int. Cl. H01S 3/10; H01S 3/13

(52) U.S. Cl. 372/25

(57) ABSTRACT

A high-power pulsed laser source has a plurality of synchronized gain elements, such as optical fibers, wherein the radiation emitted by the gain elements is combined into an overlapping output beam having a predetermined temporal characteristic. The multi-element laser source can be injection-seeded by short pulses from a seed laser or can operate as a synchronized Q-switched source. The disclosed laser source is suitable for optical pumping of short wavelength plasma sources.

### FIELD OF THE INVENTION

The invention relates to a high-power pulsed laser device, and more particularly to a laser device with a plurality of synchronized gain elements, in particular optical fibers, emitting an overlapping output beam suitable for optical pumping of short wavelength plasma sources.

### BACKGROUND OF THE INVENTION

Many applications require high-power lasers with a suitable pulse width and capable of a high repetition rate. For example, extreme ultraviolet (EUV) light sources operating around 130 Å are desirable for EUV micro-lithography applications in semiconductor manufacturing. Laser plasma sources employed in EUV lithography require drivers that deliver 1-2 J pulses with a pulse width of 3-4 ns and a repetition rate of 5-10 kHz that can be focused to a 100-200 μm diameter spot size. As another example, parallel florescence assays for high throughput drug screening, laser assisted desorption mass spectroscopy and high speed laser chemical vapor deposition require synchronized short high power pulse trains at high repetition rate. Other applications include metal cutting, and welding applications.

Most high power laser systems in use today to create plasmas for EUV generation are fabricated from rare-earth-doped crystals or glass rods/slabs, typically configured in a Master Oscillator Power Amplifier (MOPA) configuration. The gain elements of the MOPA's are typically optically pumped, e.g., end-pumped, by laser diodes. Most of these high power laser systems operate in pulsed output mode. A laser oscillator delivers a low-energy seed pulse of the correct pulse duration suitable for a particular application. The laser beam can then be expanded and amplified by additional optical amplifiers which can be multi-pass.

Recently, cladding-pumped high-power pulsed fiber lasers have been reported (Optoelectronics Research Center, University of Southampton, UK) which produce 7.7 mJ of pulsed optical energy at low repetition rates and 10 W of average optical output power at higher repetition rates. The fibers have a 60 μm diameter Yb-doped core and emit at a wavelength of 1080 nm. The pulse energy can be increased by enlarging the core diameter, albeit at the expense of diminished beam quality as a result of higher order modes and a more difficult thermal management.

The average output could also be increased by operating many fiber lasers in parallel and subsequently combining their output beams to generate an overlapping or coaxial output beam with an optical energy that is essentially equal to the sum of the optical energies of the output beams of the individual fiber lasers.

However, combining a plurality of laser beams into an overlapping output beam, in particular a high power beam having a spectral characteristic and pulse duration suitable for pumping Extreme Ultra-Violet (EUV) plasma sources, is difficult. For example, U.S. Pat. No. 6,192,062 describes a free space external cavity laser having a plurality of gain elements, which may be a semiconductor laser array or a fiber laser array. Each gain element produces an optical output beam with a distinct wavelength. The output beams are combined into a single overlapping beam by a dispersive element, for example a grating, containing the mixture of the wavelengths of the individual output beams with a total output energy substantially equal to the sum of the energies contained in the individual output beams. The overlapping beam disclosed in the U.S. Pat. No. 6,192,062 patent can be CW or pulsed.

Generation of pulses of short time duration using fiber lasers using Q-switching. Q-switched fiber lasers have been described, for example, by W. L. Barnes “Q-Switched Fiber Lasers” in Rare Earth doped Fiber Lasers and Amplifiers, M. J. F Digonnet, ed., Marcel Dekker, Inc., New York, pp. 375-391. The high gain of fiber lasers, which makes them advantageous CW sources, requires modulators for Q-switching with a very high extinction ratio. Methods for Q-switching include mechanical choppers, electro-optic and acousto-optic Q-switching, as well as passive Q-switching using saturable absorbers.

However, there is still a need for synchronizing the optical output of multiple gain elements to produce high-energy pulses with a suitable pulse duration, focusing and a high pulse repetition rate (greater than 1 kHz) suitable for optical pumping, in particular for pumping a plasma source emitting optical radiation in the Extended UV (EUV) wavelength range, for example at wavelengths of less than approximately 15 nm.

### SUMMARY OF THE INVENTION

The invention is directed to a high-power pulsed laser source, and more particularly to a laser source with a plurality of synchronized gain elements, in particular optical fibers, emitting an overlapping output beam suitable for optical pumping of short wavelength plasma sources.

According to one aspect of the invention, a device for producing a pulsed optical output beam from a pulsed optical seed beam includes a plurality of optically pumped gain elements; a seed laser having a spectral bandwidth and producing the pulsed optical seed beam; at least one diffracting element that diffracts the pulsed optical seed beam to produce a plurality of diffracted seed beams having a spectral bandwidth smaller than the spectral bandwidth of the seed laser; wherein the plurality of optically pumped gain elements receive and amplify the plurality of diffracted seed beams to produce amplified output beams having a duration that is longer than the duration of the pulsed seed beam.

According to another aspect of the invention, an optically pumped plasma source for generating electromagnetic radiation, which includes a plasma target; and an optical pump producing a high-energy pulsed optical output beam which is intercepted by the target. The optical pump for pumping the plasma target includes a plurality of optically pumped gain elements; a seed laser having a spectral bandwidth and producing a pulsed optical seed beam with a pulse duration; a diffracting element that diffracts the pulsed optical seed beam to produce a plurality of diffracted seed beams having a smaller spectral bandwidth; wherein the plurality of optically pumped gain elements receive and amplify the diffracted seed beams to produce an overlapping amplified output beam having a pulse duration that is longer than the pulse duration of the pulsed seed beam.

According to yet another aspect of the invention, a multi-wavelength pulsed laser device includes a free space external cavity; a plurality of optically pumped gain elements disposed in the cavity, each gain element capable of emitting optical radiation at a specified wavelength; a diffracting element intercepting and diffracting the emitted optical radiation to form an overlapping beam; and a Q-switch disposed inside the external cavity and intercepting the overlapping beam, wherein the Q-switch synchronizes the optical radiation emitted by the gain element to form the overlapping beam in form of a synchronized overlapping pulsed beam.

Embodiments of the invention may include one or more of the following features. The device may have a single diffractive element or two diffractive elements and an additional lens or lenses that collimates the amplified output beams and directs the collimated beams to a diffracting element to form the pulsed optical output beam. The pulsed optical output beam is an overlapping beam formed of the amplified output beams. The device can be a MOPA or an external cavity laser, whereby in the latter case, an external cavity mirror intercepts the overlapping beam. An optical switching element, such as a Pockels cell, adapted to switch between a substantially transparent state and a substantially opaque state and disposed so as to intercept the overlapping beam. If the device has an external cavity, the optical switching element can be disposed between the diffracting element and the external cavity mirror so as to intercept the pulsed optical output beam and switch the pulsed optical output beam between a first optical path for reflection by the external cavity mirror and a second path for transmission into free space.

The external cavity may include a second optical switching element adapted to switch between a substantially transparent state and a substantially opaque state, the second optical switching element configured to receive the an pulsed optical seed beam and switching the pulsed optical seed beam for transmission to the at least one diffracting element. The pulse duration of the pulsed optical seed beam the second optical switching element may be determined from the duration of an electric pulse pumping the laser or from the duration of an open-state of the second optical switching element. The pitch between the diffracted seed beams and the gain elements device can changed by a pitch transformer having a plurality of optical waveguides, each waveguide configured with two ends, with a spacing between first ends of the waveguides being smaller than a spacing between second ends of the waveguides, the first ends of the waveguides receiving the diffracted seed beams, which pass through the plurality of waveguides and exit the second ends of the waveguides to be received by the plurality of optically pumped gain elements. Alternatively or in addition, a relay lens configuration may be used to adapt the pitch of the fibers with that of the gain elements.

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows an array of gain media in a common Q-switched external cavity;

FIG. 2 shows stretching synchronized by a picosecond injection laser;

FIG. 3 illustrates schematically the concept of pulse stretching with a dispersive element;

FIG. 4 is a different embodiment of an injection-seeded laser array with pulse stretching;

FIG. 5 shows a pitch transformer allowing a wider spacing between gain elements;

FIG. 6 shows schematically a plasma optically pumped with a pump source according to FIGS. 2 or 4; and

FIG. 7 shows schematically a MOPA array with a shaped seed pulse.

### DETAILED DESCRIPTION OF CERTAIN ILLUSTRATED EMBODIMENTS

The system described herein is directed to arrays of gain elements located in an external cavity and capable of generating synchronized high energy optical pulses. In particular, the system described herein employs fiber gain media that are synchronized with a common seed laser pulse and can operate either as an optical amplifier or as a laser.

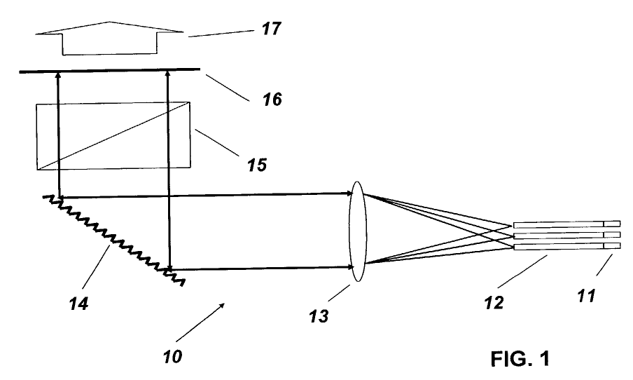

Referring first to FIG. 1, a laser system 10 includes an optical cavity formed by a semitransparent output coupling mirror 16 and the distal end faces of the gain elements 12, such as optical fibers. The gain elements 12 can be optical fibers and optically pumped by an external pump, for example, laser diodes 11. Optical beams emitted by the fibers 12 are collimated by a lens 13, with the collimated beams impinging on a dispersive element 14, such as a grating, that diffracts the collimated beams to form an overlapping, preferably coaxial beam 17. The overlapping beam 17 passes through a Q-switch 15 and the output coupling mirror 16. Each gain element 12 lases at a different wavelength within the gain curve of the gain medium, with the wavelength of the gain elements determined by their placement and the dispersive characteristic of the grating 14. As mentioned above, each gain element can provide high energy optical pulses with pulse energies of approximately 1 mJ per pulse having a duration of approximately 1-50 ns at a repetition rate of 1-10 kHz.

The short output pulses of the combined overlapping beam 17 can be produced by Q-switching in the following manner. The high finesse (Q) of the laser cavity is lowered while the gain elements 12 are being optically pumped by the pump sources 11. During this time, the population inversion in the gain medium increases since lasing oscillation are inhibited by the low Q of the cavity. The Q-switch 15 then rapidly restores the Q of the cavity, thereby quickly exhausting the population inversion and thus enabling lasing over a short period of time. This produces the Q-switched pulse. A long fiber (>1 meter) will generate a pulse with a duration greater than 20 nanoseconds. Shorter pulses may be obtained with very short cavity lengths or by placing a “pulse-shaping” optical switch outside of the cavity.

One type of Q-switch or “pulse-shaping” optical switch is, for example, a Pockels cell which can be made of various birefringent materials, depending on the desired wavelength range, such as BBO crystals (wavelength 200 nm to 1064 nm), KD*P crystals (wavelength 300 nm to 1064 nm), Lithium Niobate crystals cell for (wavelength 600 nm to 4500 nm) Q-Switching. BBO crystal Pockels cells have a low insertion loss, resonance free operation, and a high damage threshold so as to withstand average powers in excess of 20 KW/cm² (CW).

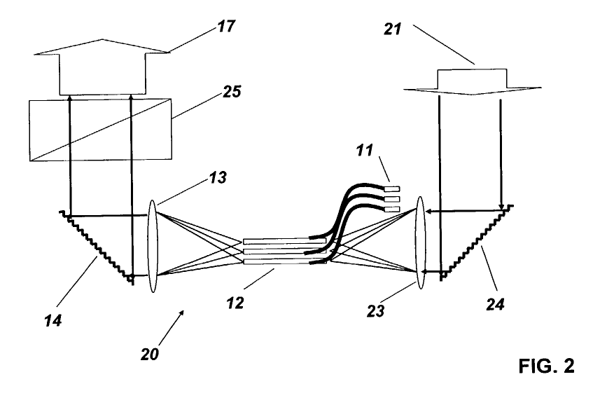

FIG. 2 shows an embodiment of a pulsed MOPA-type coherent source 20 wherein a seed pulse produced by a seed laser 21 is amplified by traversing the gain medium 12 in a single pass. The seed laser 21 can be a pulsed diode laser or another multi-wavelength pulsed laser source with a spectral output that overlaps with the gain curve of the gain medium 12.

System 20, being implemented as a MOPA, does not require an external cavity. The gain medium 12 can be a semiconductor, optical fibers or any other medium exhibiting optical gain. The exemplary fibers 12 are preferably end-pumped by diode lasers 11, with the pump light propagating in the fiber cladding. The short (ps) pulses emitted by the seed laser 21 have a wavelength within the gain curve of the MOPA gain medium 12. The beam emitted from the seed laser 21 strikes a first grating 24, where the beam is diffracted, with the diffracted beams being collimated by a lens 23 and impinging on the distal end faces (the end faces facing lens 23) of the MOPA fiber array 12. Each distal end face of the gain elements facing the lens 23 receives a diffracted beam of a particular wavelength, depending on the grating dispersion and the position of the gain elements. The respective seed laser wavelength is then amplified by each gain element and emitted on the proximate end face of the MOPA facing the diffractive element 14. The emitted beam is then collimated by the second lens 13 and combined through diffraction on the second diffractive element 14 to form an overlapping high power pulsed beam having all the wavelengths of the individual MOPA's. An optical isolator, such as a Faraday rotator, a dye cell, a Pockels cell 25 or another type of optical isolator, can be placed in the output beam 17 to prevent back-reflection of light into the gain elements, which could result in unwanted lasing in the absence of the seed pulses.

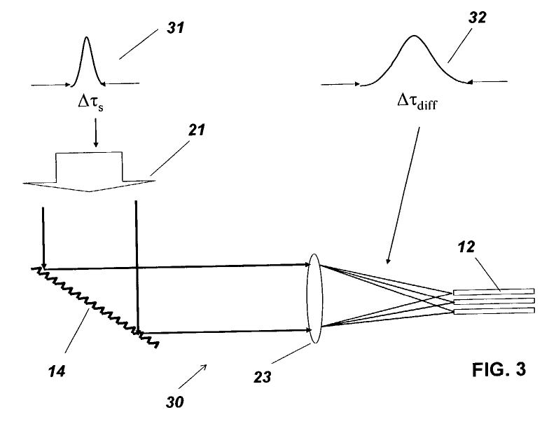

The purpose of the diffractive element 24 to couple the pulses from seed laser 21 into the gain elements 12 is two-fold. Firstly, each gain element amplifies a signal with a slightly different wavelength defined by the diffracted beams. The amplified beams can then be conveniently recombined with the second grating 14. Combining multiple lasers beams that have substantially the same wavelength requires complex reflective optics and can hence be expected to be more difficult and costly. Secondly, the grating 24 “stretches” the seed pulse by increasing its time duration, potentially by several orders of magnitude, over that of the seed beam. This aspect, which will now be explained with reference to FIG. 3, is of significance for effectively exciting a plasma for the generation of EUV light, for example, for fine-line lithography in semiconductor processing applications.

As seen in FIG. 3, the temporal characteristic of a pulsed laser beam 21 can be altered with a diffractive element 14. The input seed pulse from seed laser 21 has a temporal characteristic 31 with an effective pulse duration Δτₛ=2/Δνₛ, wherein Δνₛ, is the oscillating bandwidth of the pulse. The seed laser beam is diffracted by the diffractive element 14 and focused by lens 23 onto the gain elements 12. The focused beams have a narrower bandwidth Δν_{diff} than the bandwidth Δνₛ of the original seed beam, which corresponds to the fraction

$$F = \frac{Δ {v}_{diff}}{Δ {v}_{s}}$$

of the oscillating bandwidth Δνₛ that is captured by each gain element 12. For example, if F has a value of 300, then a seed pulse width of 10 ps would produce a stretched seed pulse with a duration of 300*10 ps or 3 ns at each fiber input. The narrower bandwidth translates into a greater pulse width Δτ_{diff} as shown schematically as curve 32 in FIG. 3.

In addition, conventional techniques may be used to flatten the intensity profile of the seed pulses across all fiber amplifiers. It is evident that a smaller or greater oscillating bandwidth can be selected from the total oscillating bandwidth of the seed laser by using a suitable grating and spacing of the gain elements, hence generating stretched pulses having various durations. The design and operation of an all-reflective on-axis pulse stretcher is described, for example, in P. S. Banks et al., “Novel all-reflective stretcher for chirped-pulse amplification of ultrashort pulses”, IEEE J. Quantum Electron., vol. 36, pp. 268-274, 2000.

An additional etalon can be placed between the seed pulse laser and grating to prevent non useful wavelengths from impinging on the gain elements. Since the energy of the seed pulse is divided between the fibers, each gain element of the MOPA must display significant gain, for example, a gain of 1000 or more, which is readily attainable with active optical fibers.

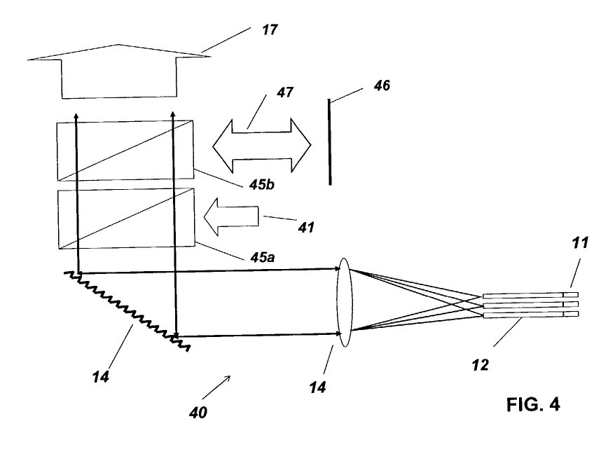

FIG. 4 shows a different embodiment implemented as a regenerative pulse stretching amplifier 40, also using a short injection seed pulse 41. Unlike the embodiment of FIG. 2, a single grating 14 is employed, with back-reflection of the amplified signal into the seed laser 41 prevented or at least attenuated by a beam splitter 45a, for example, a polarization beam splitter or a Pockels cell. Also, unlike the embodiment of FIG. 2 wherein the MOPA amplifies the seed pulse in a single pass through the gain element without the need for an external cavity, the embodiment of FIG. 4 has an external laser cavity formed between the distal end mirrors (not shown) of the fiber gain array 12 located near the optical pumps 11 and high reflectivity mirror 46. The system of FIG. 4 employs a second polarizing beam splitter 45b, such as a second Pockels cells 45b, through which a linearly polarized cavity light beam 47 is deflected to a high reflectance mirror 46. After 5-10 cavity round trips, the state of the second Pockels cell 45b is changed and the light circulating in the external cavity is switched out of the cavity, as indicated by arrow 17, and can be directed to a target (not shown). The regenerative amplifier configuration 40 uses the gain medium very efficiently via multiple cavity round trips of the seed pulse.

The fibers used for this laser may be single-mode or multimode fibers. Use of multimode fibers spoils the phase coherence of the individual fibers and prevents the amplified light from reforming a short pulse. In addition because only a portion of the input spectrum is used, this also helps to prevent reformation as a coherent short pulse. The design goal of the laser is to get the most energy out of each fiber for each pulse, in order to minimize the number of fibers used and maximize the total energy extracted. Also the fibers should be relatively small to minimize the intrinsic laser divergence, in order to generate a small focal spot on target. Thus fiber core diameters of 20-50 μm are preferable. The maximum energy extracted in a short pulse from a fiber is limited by the damage threshold of the core glass, which can be in excess of 10-20 MW/cm².

The energy achievable with the proposed system will also depend on the number of gain elements that can be simultaneously pumped. In order to capture and spectrally separate the seed pulse for the individual gain elements, the cores of the fibers should be spaced as closely as possible.

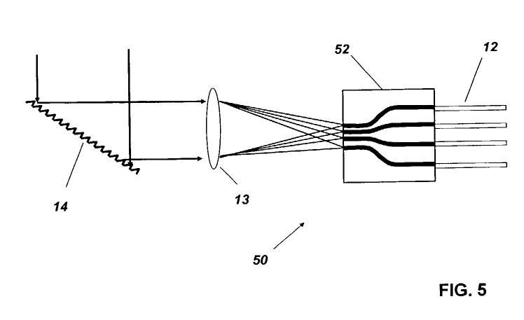

Clad fibers are typically 200-300 μm in diameter. Aligning 250 fibers with the cladding intact would result in a linear array with a width of 5 cm. It may therefore be desirable to space the fiber cores more closely to improve the focusing, uniformity and hence the performance of the system. One possible way of decreasing the fiber spacing is to reduce the diameter of the cladding or to remove the cladding altogether. Alternatively, as shown in FIG. 5, the fibers 12 could be connected to a pitch converter 50, for example, implemented as waveguides integrated on a common substrate 52. converter 50, for example, implemented as waveguides integrated on a common substrate 52. Yet another method can include relay optics to bring the beams close together. With any of these approaches, a fiber pitch at the input and output of the fibers of less than 100 μm for a 50 μm core maybe obtained.

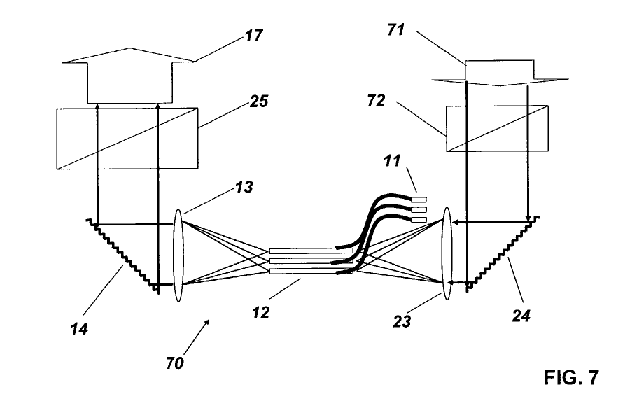

FIG. 7 illustrates an exemplary system 70 for producing an optical high-power pulsed output beam wherein the gain elements 12 receive a shaped seed pulse from a Q-switched or cw multi-frequency fiber laser or diode laser. The correct pulse length can herein be defined by pulse-shaping with a Pockels cell placed, for example, between the seed laser 71 and the grating 24. The other elements are identical to and perform the same function as those depicted in system 20 of FIG. 2 and system 40 of FIG. 4.

Additional linear array external cavity lasers (not shown) could be stacked or combined in a manner known in the art, with the seed pulse injected simultaneously into all the arrays. In this way, systems with 1000 or more lasers could be built.

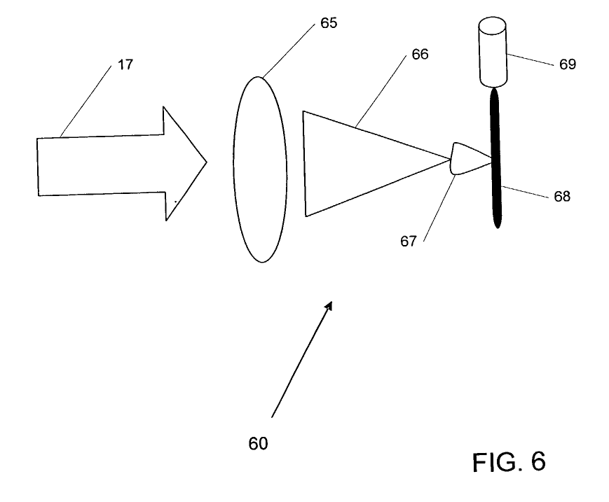

As shown in FIG. 6 and mentioned above, in a system 60, the output beam 17 of the aforedescribed laser source can be focused by a lens 65 to form a focused beam 66 impinging on a target 68, such as a Xenon gas jet, exiting from an orifice 69. The focused beam 66 then excites a plasma 67 that can generate EUV and/or soft x-rays in a wavelength range of 60-130 Å. EUV and soft x-ray radiation is useful for photolithography applications in semiconductor manufacturing.

The laser source can also be used to produce x-rays at a wavelength of around 10 Å. This source can also be used by itself as a time-locked source of long-wavelength, high-energy nanosecond pulses. Those skilled in the art will recognize that these pulses may be frequency-converted into the green, blue or ultraviolet regions of the spectrum for use with laser-assisted Chemical Vapor Deposition (CVD) or to drive large arrays of fluorescence assays in high throughput drug screening applications. Other applications for this laser may be envisioned.

While the invention has been disclosed in connection with the preferred embodiments shown and described in detail, various modifications and improvements thereon will become readily apparent to those skilled in the art. For example, instead of using optical fibers as a gain medium, a gain medium may be fabricated on a planar surface as an array of optical waveguides, as is done in the fabrication of semiconductor waveguide amplifiers for communications systems. This fabrication method alleviates the requirement of handling multiple fibers. Accordingly, the spirit and scope of the present invention is to be limited only by the following claims.

What is claimed is:

1. A device for producing a pulsed optical output beam from a pulsed optical seed beam, comprising:
a plurality of optically pumped gain elements;
a seed laser having a spectral bandwidth and a pulse duration and producing the pulsed optical seed beam;
at least one diffracting element that diffracts the pulsed optical seed beam to produce a plurality of diffracted seed beams having a spectral bandwidth smaller than the spectral bandwidth of the seed laser;
wherein the plurality of optically pumped gain elements receive and amplify the plurality of diffracted seed beams to produce amplified output beams having a pulse duration that is longer than the pulse duration of the pulsed seed beam.

2. The device of claim 1, further comprising a lens that collimates the amplified output beams and directs said collimated beams to a diffracting element to form the pulsed optical output beam.

3. The device of claim 1, wherein said pulsed optical output beam is an overlapping beam formed of the amplified output beams.

4. The device of claim 3, further comprising an external cavity mirror intercepting said overlapping beam.

5. The device of claim 3, further comprising an optical switching element adapted to switch between a substantially transparent state and a substantially opaque state and disposed so as to intercept the overlapping beam.

6. The device of claim 5, wherein said optical switching element comprises a Pockels cell.

7. The device of claim 4, further comprising a first optical switching element adapted to switch between a substantially transparent state and a substantially opaque state and disposed between the diffracting element and the external cavity mirror so as to intercept the pulsed optical output beam.

8. The device of claim 7, wherein said first optical switching element switches the pulsed optical output beam between a first optical path for reflection by the external cavity mirror and a second path for transmission into free space.

9. The device of claim 7, wherein said first optical switching element comprises a Pockets cell.

10. The device of claim 7, and further comprising a second optical switching element adapted to switch between a substantially transparent state and a substantially opaque state, said second optical switching element configured to receive the pulsed optical seed beam and switching said pulsed optical seed beam for transmission to the at least one diffracting element.

11. The device of claim 10, wherein the second optical switching element determines a pulse duration of the pulsed optical seed beam.

12. The device of claim 1, and further comprising a pitch transformer having a plurality of optical waveguides, each waveguide configured with two ends, with a spacing between first ends of said waveguides being smaller than a spacing between second ends of said waveguides, said first ends of the waveguides receiving the diffracted seed beams, which pass through the plurality of waveguides and exit the second ends of the waveguides to be received by the plurality of optically pumped gain elements, thereby changing a pitch between the diffracted seed beams and the gain elements.

13. The device of claim 1, wherein the seed laser producing the pulsed optical seed beam comprises a pulsed or CW multi-wavelength laser selected from the group consisting of fiber laser, diode laser, and microchip laser; and a pulse-shaping element disposed between the seed laser and the at least one diffracting element, said pulse-shaping element adapted to switch between a substantially transparent state and a substantially opaque state, wherein a duration of the transparent state defines the duration of the pulsed seed beam.

14. The device of claim 13, wherein the pulse-shaping element comprises a Pockels cell.

15. The device of claim 1, wherein the seed laser producing the pulsed optical seed beam comprises an electrically pulsed diode laser.

16. An optically pumped plasma source for generating electromagnetic radiation, comprising:
a plasma target; and
an optical pump producing a high-energy pulsed optical output beam which is intercepted by said target, the optical pump comprising:
a plurality of optically pumped gain elements;
a seed laser having a spectral bandwidth and producing a pulsed optical seed beam with a pulse duration;
a diffracting element that diffracts the pulsed optical seed beam to produce a plurality of diffracted seed beams having a smaller spectral bandwidth;
wherein the plurality of optically pumped gain elements receive and amplify the diffracted seed beams to produce an overlapping amplified output beam having a pulse duration that is longer than the pulse duration of the pulsed seed beam.

17. A multi-wavelength pulsed laser device comprising:
a free space external cavity comprising
a plurality of optically pumped gain elements disposed in said cavity, each gain element capable of emitting optical radiation at a specified wavelength;
a diffracting element intercepting and diffracting the emitted optical radiation to form an overlapping beam; and
a Q-switch disposed inside the external cavity and intercepting the overlapping beam,
wherein said Q-switch synchronizes said optical radiation emitted by the gain element to form the overlapping beam in form of a synchronized overlapping pulsed beam.
